(19) United States
(12) Patent Application Publication
(10) Pub. No.: US 2025/0374935 A1
(43) Pub. Date: Dec. 11, 2025

(54) Candy Making Apparatus

(71) Applicant: Beuhi, Inc., Westfield, NJ (US)

(72) Inventors: David M. Martin, Westfield, NJ (US); Richard E. Martin, Redondo Beach, CA (US); Paloma Campo, Sunnyside, NY (US); Jonathan Warnock, New York, NY (US)

(21) Appl. No.: 19/135,213

(22) PCT Filed: Oct. 11, 2023
(86) PCT No.: PCT/US2023/034905

§ 371 Date: Jun. 3, 2025

Related U.S. Application Data
(60) Provisional application No. 63/415,024, filed on Oct. 11, 2022.
(60) Provisional application No. 63/472,368, filed on Jun. 12, 2023.

(51) Int. Cl. A23G 3/02; A23G 3/48

(52) U.S. Cl. CPC A23G 3/0226; A23G 3/0215; A23G 3/0252; A23G 3/48

(57) ABSTRACT

A countertop candy making apparatus includes an ingredient staging section, a heating and mixing vessel downstream from the ingredient staging section, a cooling chamber downstream from the heating and mixing vessel, and a removable molding tray in the cooling chamber. Candy making ingredients are delivered from the ingredient staging section to the heating and mixing vessel where those ingredients are heated and mixed to form a candy formulation before being delivered into the molding tray in the cooling chamber.

### RELATED APPLICATION

This application claims priority to U.S. Provisional Patent Application Ser. Nos. 63/472,368, filed on Jun. 12, 2023, and 63/415,024, filed on Oct. 11, 2022, which are hereby incorporated by reference in their entirety.

### TECHNICAL FIELD

This document relates to a new and improved candy making apparatus that revolutionizes the way botanical-infused gummies, chocolates, and hard candies are created.

### BACKGROUND

Candy making machines have long suffered from a number of drawbacks including, but not necessarily limited to, inconsistent dispersion of botanicals and flavoring and unreliable performance leading to a candy product often having unpleasant texture and aftertaste. This document describes an at-home, countertop candy making apparatus that ensures the use of only the highest quality ingredients and provides for consistent dispersion of ingredients throughout the candy product reliably resulting in a higher quality candy product with desired texture and enhanced taste. Accordingly, the candy making apparatus of this document represents a significant advance in the at-home candy making arts.

### SUMMARY

In accordance with the purposes and benefits set forth herein, a new and improved candy making apparatus, comprises, consists of or consists essentially of: (a) an ingredient staging section, (b) a heating and mixing vessel downstream from the ingredient staging section, (c) a cooling chamber downstream from the heating and mixing vessel, and (d) a removable molding tray in the cooling chamber. Candy making ingredients are delivered from the ingredient staging section to the heating and mixing vessel where those ingredients are heated and mixed to form a candy formulation before being delivered into the molding tray in the cooling chamber. After curing, the sheet of edible candy product may be easily cut into individual pieces of any desired size.

The candy making apparatus may further include a heating element adapted for heating the heating and mixing vessel and a cooling element adapted for cooling the cooling chamber. In one or more of the many possible embodiments of the candy making apparatus, the apparatus further includes a control module including a controller, a timer, a first temperature sensor and a second temperature sensor. The first temperature sensor is adapted to sense a mixing temperature of the ingredients in the heating and mixing vessel. The second temperature sensor is adapted to sense a setting temperature in the cooling chamber. The controller is responsive to the sensed mixing temperature and the sensed setting temperature to control operation of the heating element and the cooling element and the production and processing of the edible candy product.

In one or more embodiments, the ingredient staging section includes a plurality of receivers adapted to receive and hold a plurality of different containers holding candy making ingredients. The ingredient staging section may further include an ingredient feeder or feed mechanism for each of the plurality of different containers.

In at least some embodiments, the plurality of receivers include three canister receivers and one pouch receiver. Still more specifically, the plurality of different containers may include a wet sugar canister, a dry sugar canister and a botanical ingredient canister. Still further, the plurality of different containers may include a gelatin pouch. The gelatin pouch may include a first compartment holding a gelatin powder, a second compartment holding a mixing liquid and a burstable internal seal dividing the first compartment from the second compartment. In addition, the gelatin pouch may include a discharge opening at one end and a discharge opening seal.

The three canister receivers may each include a keyed receiving collar. In such an embodiment, (a) the keyed receiving collar on a first of the three canister receivers may be adapted to match a keyed plug on a discharge end of the wet sugar canister, (b) the keyed collar on a second of the three canister receivers may be adapted to match a keyed plug on a discharge end of the dry sugar canister and (c) the keyed collar on a third of the three canister receivers may be adapted to match a keyed plug on a discharge end of the botanical ingredient canister.

In at least some embodiments of the candy making apparatus, the pouch receiver includes a pouch support stand. The ingredient feeder may include a displaceable roller, such as a pair of cooperating squeeze rollers, adapted to squeeze gelatin ingredients from the pouch so that the gelatin ingredients are displaced through the discharge opening into the heating and mixing vessel. Still further, the ingredient feeder may include a first piston adapted for pushing the wet sugar from the wet sugar canister, a second piston adapted for pushing the dry sugar from the dry sugar canister and a third piston adapted for pushing the botanical ingredients from the botanical canister. In such an embodiment, the ingredient feeder may also include a first driver adapted for displacing the displaceable roller, a second driver adapted for displacing the first piston, a third driver adapted for displacing the second piston and a fourth driver adapted for displacing the third piston. The controller may be further adapted to control operation of the first driver, the second driver, the third driver and the fourth driver.

In one or more embodiments of the candy making apparatus, the candy making apparatus further includes an agitator in the mixing vessel adapted for mixing the candy making ingredients during heating. In one or more embodiments of the candy making apparatus, the candy making apparatus further includes a vibrator adapted for vibrating the molding tray and removing air bubbles in the candy formulation discharged into the molding tray. In one or more embodiments of the candy making apparatus, the candy making apparatus further includes a tipper adapted for pouring the candy formulation from the heating and mixing vessel into the molding tray. The controller may be further adapted to control operation of the agitator, the vibrator and the tipper.

In at least some of the many possible embodiments, the candy making apparatus further includes an ingredient scanner adapted to read a code on at least one of the plurality of different containers. In such an embodiment, the controller is responsive to the code read by the ingredient scanner to confirm the ingredient in the at least one of the plurality of different containers is of the highest quality and freshness and approved for use to produce the edible candy product.

In the following description, there are shown and described several different embodiments of the new and improved candy making apparatus. As it should be realized, the candy making apparatus is capable of other, different embodiments and its several details are capable of modification in various, obvious aspects all without departing from the candy making apparatus as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein by reference and forming a part of the specification, illustrate several aspects of the candy making apparatus and together with the description serve to explain certain principles thereof.

FIG. 1 is a schematic representation of the new and improved candy making apparatus.

FIG. 2 is a schematic representation of the control module of the candy making apparatus set forth in FIG. 1.

FIG. 3A is a detailed side elevational view of one possible embodiment of an ingredient canister for use in the candy making apparatus.

FIG. 3B is a detailed side elevational view of one possible embodiment of a gelatin pouch for use in the candy making apparatus.

FIG. 4 is a perspective illustration of one possible embodiment of the candy making apparatus.

FIG. 5 is a detailed perspective view of the ingredient staging section of the embodiment illustrated in FIG. 4, illustrating the roller in the home or starting position.

FIG. 6 is a detailed perspective view of the ingredient staging section of the embodiment illustrated in FIG. 4, illustrating the roller in the fully advanced and discharging position.

FIG. 7A is a detailed elevational view illustrating the heating and mixing vessel in the heating and mixing position.

FIG. 7B is a detailed elevational view illustrating the heating and mixing vessel in the pouring position following the pouring of all of the candy formulation from the heating and mixing vessel into the underlying molding tray.

Reference will now be made in detail to the presently preferred embodiments of the candy making apparatus.

### DETAILED DESCRIPTION

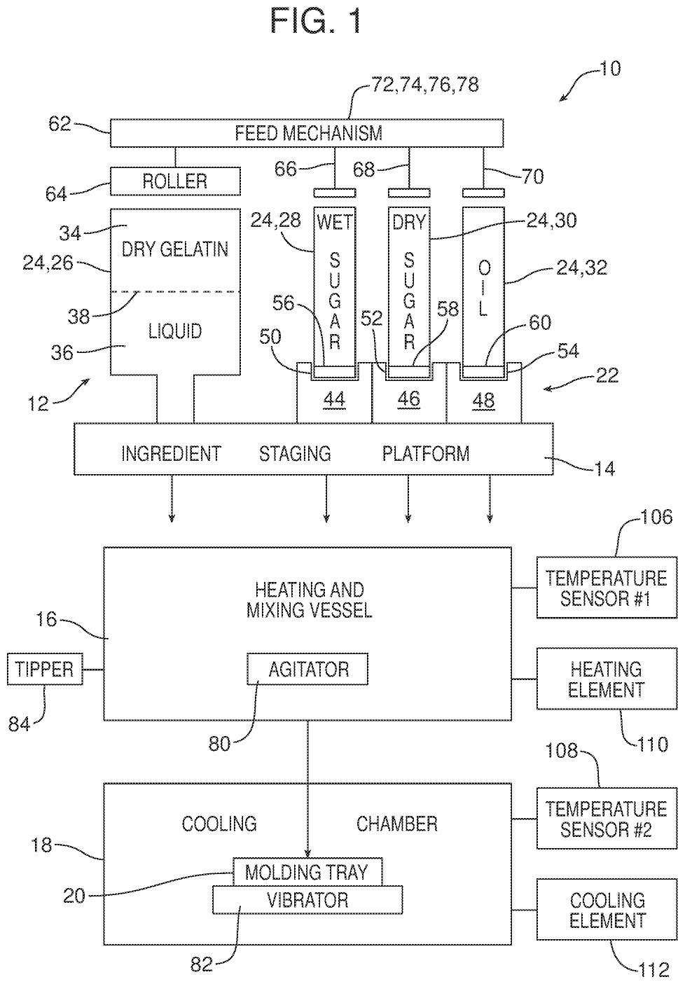

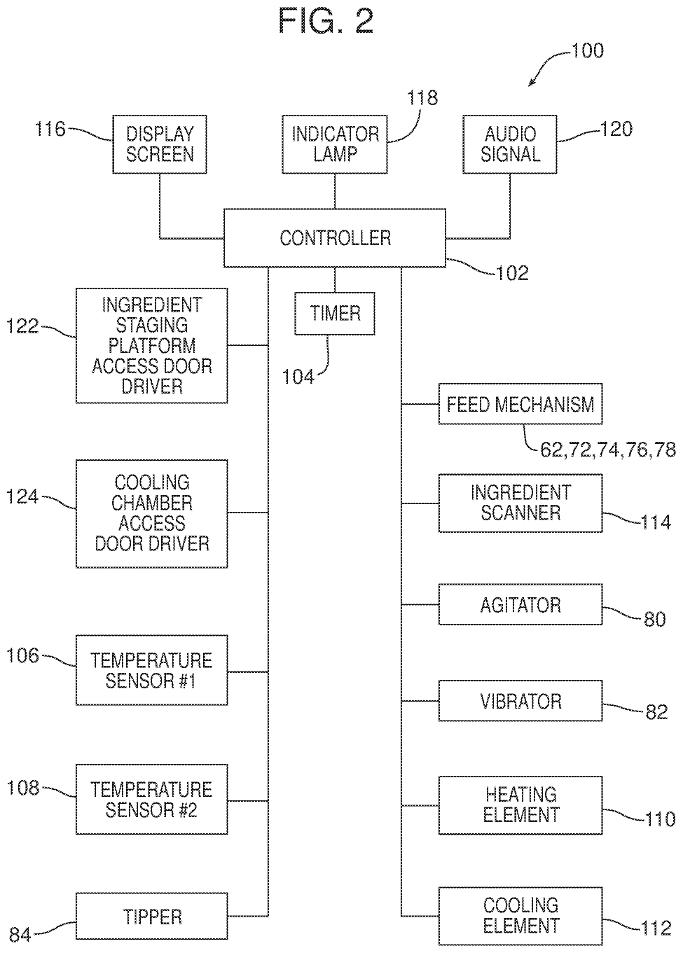

Reference is now made to FIGS. 1 and 2 schematically illustrating the new and improved candy making apparatus 10. As illustrated, the candy making apparatus 10 includes an ingredient staging section 12 having an ingredient staging platform 14. A heating and mixing vessel 16 is located downstream from the ingredient staging section 12. A cooling chamber 18 is located downstream from the heating and mixing vessel 16. A removable, non-stick, food-grade molding tray 20 is held in the cooling chamber 18.

The ingredient staging section 12 includes a plurality of receivers 22 that are adapted to receive and hold a plurality of different ingredient containers 24. As illustrated the containers 24 include a flexible plastic pouch 26 and three ingredient canisters 28, 30, 32. The pouch 26 may be made from any appropriate flexible food grade pouch material and is preferably transparent. The canisters 28, 30, 32 may be made from any appropriate material including, but not necessarily limited to metal, plastic and paperboard. Ideally, all of the containers 24 can be recyclable. The pouch 26 and the canisters 28, 30, 32 can be designed to prevent easy tampering and/or counterfeiting, thereby ensuring the authenticity of the enclosed ingredients. In some embodiments, the canisters hold about 3 ounces of ingredients. The contents of the canisters 28, 30, 32 may be sticky or viscous so the inner canister walls may be lined with anti-stick materials/surfaces of any type known in the art to be suitable for such a purpose (e.g. polytetrafluoroethylene).

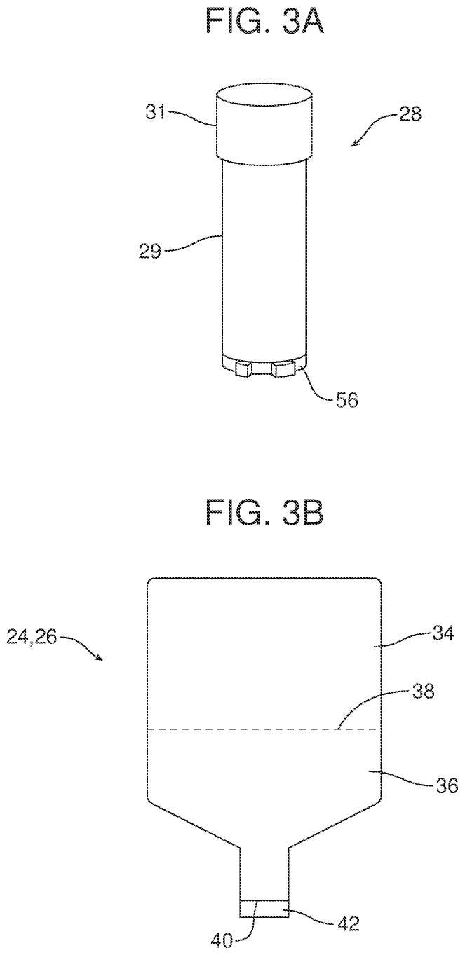

In one possible embodiment shown in FIG. 3B, the pouch 26 includes: (a) a first internal compartment 34, adapted for holding a gelatin powder, (b) a second internal compartment 36 adapted for holding a mixing liquid (e.g. water, juice, tea, cola or other liquid flavoring) and (c) a burstable internal seal dividing the first and second compartments. The pouch 26 also includes a discharge opening 40 at one end and a discharge opening seal 42. The canister 28 holds a wet sugar, the canister 30 holds a dry sugar and the canister 32 holds a botanical ingredient such as an oil, resin, powder or tincture.

The receivers 22 include a pouch support stand 42 and three canister receivers 44, 46, 48. Each canister receiver 44, 46, 48 includes a uniquely keyed receiving collar 50, 52, 54. The first keyed receiving collar 50 of the first canister receiver 44 is adapted to match a keyed plug 56 on a discharge end of the wet sugar canister 28. The second keyed receiving collar 52 of the second canister receiver 46 is adapted to match a keyed plug 58 on a discharge end of the dry sugar canister 30. The third keyed receiving collar 54 of the third canister receiver 48 is adapted to match a keyed plug 60 on a discharge end of the botanical ingredient canister 32. The key for the wet sugar, the dry sugar and the botanical ingredient all differ to ensure that each of the ingredients is connected or plugged into the proper receiver 44, 46 or 48. Color coding may also be employed to allow one to more easily match the proper ingredients with the proper receivers.

As further illustrated in FIG. 1, the ingredient staging section 12 also includes an ingredient feeder or feed mechanism 62 for each of the plurality of different containers 24. As shown in FIG. 1, the feed mechanism 62 includes a displaceable roller 64, such as a pair of cooperating squeeze rollers, adapted, at the proper time, for squeezing the pouch 26 held in the pouch support stand 42 so that gelatin ingredients are squeezed through the discharge opening 40 into the underlying heating and mixing vessel 16 as will be described in greater detail below.

The feed mechanism 62 also includes: (a) a first piston 66 sized, shaped and adapted for pushing the wet sugar from the wet sugar canister 28, (b) a second piston 68 sized, shaped and adapted for pushing the dry sugar from the dry sugar canister 30, and (c) a third piston 70 sized, shaped and adapted for pushing the botanical ingredients from the botanical canister 32. Toward this end, the feed mechanism 62 further includes: (a) a first driver 72 adapted for displacing the roller 64, (b) a second driver 74 adapted for displacing the first piston 66, (c) a third driver 76 adapted for displacing the second piston 68, and (d) a fourth driver 78 adapted for displacing the third piston 70. The first, second, third and fourth drivers 72, 74, 76 and 78 are all of a type known in the art to be useful for such a purpose.

The candy making apparatus 10 also includes an agitator 80, of a type known in the art, in the heating and mixing vessel 16. Such an agitator 80 is adapted to mix the candy making ingredients added to the vessel into a candy formulation. The molding tray 20 sits on a vibrator 82, in the form of a plate, adapted to hold the molding tray and remove air bubbles from the candy formulation once it is delivered into the tray. In addition, the candy making apparatus 10 includes a tipper 84 that is adapted for pouring the candy formulation from the heating and mixing vessel 16 into the underlying molding tray 20 in controlled manner.

Reference is now made to FIG. 2 which schematically illustrates the control module 100 of the candy making apparatus 10. The control module includes a controller 102, in the form of a computing device such as (a) an electronic control unit (ECU) controlled by appropriate control software or (b) a dedicated microprocessor with appropriate hardware adapted to control the candy making process. The control module 100 also includes a timer 104, a first temperature sensor 106 and a second temperature sensor 108. The timer 104, which may be integrated into the controller 102, is adapted for timing various steps of the candy making process. The first temperature sensor 106 is adapted to sense a mixing temperature of the ingredients in the heating and mixing vessel 16. The second temperature sensor 108 is adapted to sense a setting temperature in the cooling chamber 18. The controller 102 is responsive to the sensed mixing temperature and the sensed setting temperature to control (a) operation of a heating element 110, of a type known in the art and adapted for heating the heating and mixing vessel 16, (b) a cooling element 112, of a type known in the art and adapted for cooling the cooing chamber 18, and (c) the overall production and processing of edible candy product.

It should also be appreciated that the controller 102 is also adapted or configured to control operation of the first, second, third and fourth drivers 72, 74, 76, 78 for the timed and controlled delivery of the various ingredients (gelatin, wet sugar, dry sugar and botanicals) to the heating and mixing vessel 16.

In order to ensure the freshness and the quality of the candy making ingredients, each container 24 may include a code, such as a bar code indicating, for example, the source, date of packaging, type of ingredient and other critical information for the contents of each container. The candy making apparatus 10 may include an ingredient scanner 114 adapted to read the code on each container 24. The controller 102 receives the container code information from the ingredient scanner 114 and responds by confirming that the ingredient is each container is fresh and of a quality suited for making the best edible candy product. Thus, quality control for each batch of candy product is ensured.

As further illustrated in FIG. 2, the control module 100 may also include a display screen 116 adapted for communication between the controller and the operator/user of the apparatus. As an example, the controller 102 may display on the display screen 116 appropriate operating instructions for the user to follow at any particular time during the candy making process. The display screen 116 may be a touch screen and function as a controller/user interface. In some embodiments, the controller 102 may include an integrated voice processing unit for voice communication with the user.

Similarly, the control module 100 may include one or more indicator lamps 118 or audio signaling devices 120 of a type known in the art to provide indications to the operator/user of the operating status of the apparatus 10. For example, a green indicator lamp or buzzer may indicate when the candy making process has been completed. Some embodiments of the apparatus 10 may also include a first access door (not shown) that controls access to the ingredient staging section within the housing of the apparatus and a second access door (not shown) that controls access to the cooling chamber 18 for placement and removal of the molding tray 20. The control module 100 may include drivers 122, 124 for opening and closing these access doors in response to commands from the controller 102.

The candy making apparatus 10 described above is useful in a method or process for making edible candy product that will be described in detail below.

First the user selects the ingredients to be used to make the edible candy product. The access door to the ingredient staging section 12 is then opened. Canisters 28, 30, 32, holding the desired wet sugar, dry sugar and botanical ingredients are then inserted and locked into the corresponding canister receivers 44, 46, 48. Color coding of the canisters 28, 30 and 32 and the receivers 44, 46 and 48 makes it easy to match the ingredient canisters with the proper receivers and the keying, discussed above, ensures only authentic canisters with authentic ingredients are properly connected to the apparatus and used in the candy making process. The ingredient scanner 114 and controller 102 function together as a final quality control assurance minder.

FIG. 3A illustrates one possible embodiment of a canister 28, including a cylindrical body 29 closed at one end by a cap 31 opposite the keyed plug 56. In one possible embodiment, the cap 31 is adapted to receive the plunger or piston 66 that will force the ingredients from the canister 28. In other embodiments, the cap 31 is removed after connection of the canister 28 to the canister receiver 44.

Next, one manually squeezes the pouch 26 to rupture or burst the internal seal 38 and mix the dry gelatin and liquid in the two internal chambers 34, 36 to form a gelatin bloom. The pouch 26 is then loaded onto the pouch support stand 42. Once all of the ingredients are properly loaded into ingredient staging section 12 of the apparatus 10 as determined by internal sensors (not shown) connected to the controller 102, the controller advises the operator or user through the display screen 116 an indicator lamp 118 and/or audio signaling device 120 that the apparatus is ready to start the candy making process.

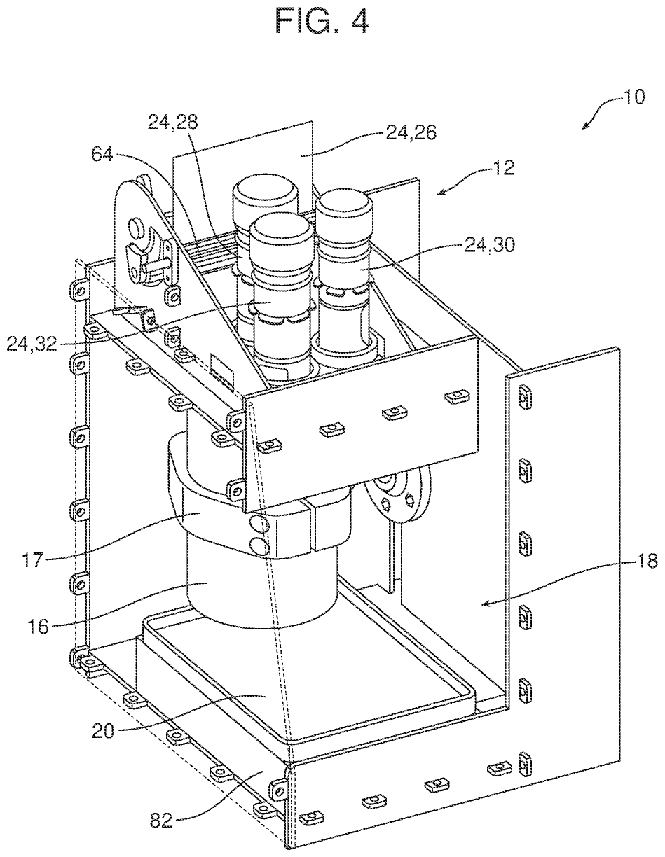

The molding tray 20 is then loaded into the cooling chamber 18 through the open access door. More specifically, the tray 20 nests in a slight depression or cavity formed in the top of the vibrator 82. Proper seating of the molding tray 20 on the vibrator 82 may be confirmed by a sensor (not shown) in communication with the controller 102. FIG. 4 illustrates all of the containers 24 properly loaded into the apparatus 10 in the ingredient staging section 12 above the heating and mixing vessel 16 and the molding tray 20 in the cooling chamber 18.

Once the tray 20 is properly seated, the controller 102 advises the operator/user through the display screen 116 or indicator lamp 118. The cooling chamber door may then be closed. The controller 102 may then display a timeline of the candy making process on the display screen 116 for the edification of the operator/user. The candy making process is then initiated either automatically by the controller 102 or in response to operator/user input such as by voice command, where the controller includes an integrated voice processor, or through the touch screen display 116.

At this time, the controller 102 controls the operation of the drivers 74, 76 to discharge the wet and dry sugars from the first and second canisters 28, 30 into the heating and mixing chamber. Next, the controller 102 controls operation of the heating element 110 to heat the heating and mixing vessel 16 to a first predetermined cooking temperature, depending upon the type of candy being made (e.g. gummies, chocolates, hard candy) of, for example, about 50° C. to about 152° C. as monitored and confirmed by the first temperature sensor 106. As the wet and dry sugars in the heating and mixing vessel 16 are being heated, the controller 102 also activates the agitator 80 to provide for complete mixing of the sugars into a homogeneous mixture. Once the cooking temperature is reached, as confirmed by the first temperature sensor 106, the controller 102 deactivates the heating element 110 while mixing continues.

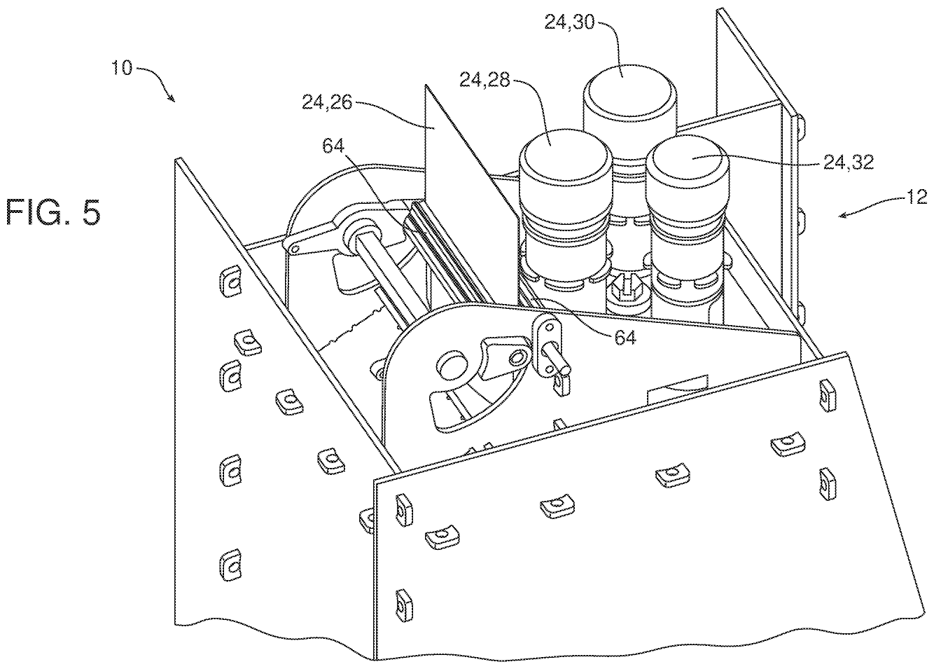

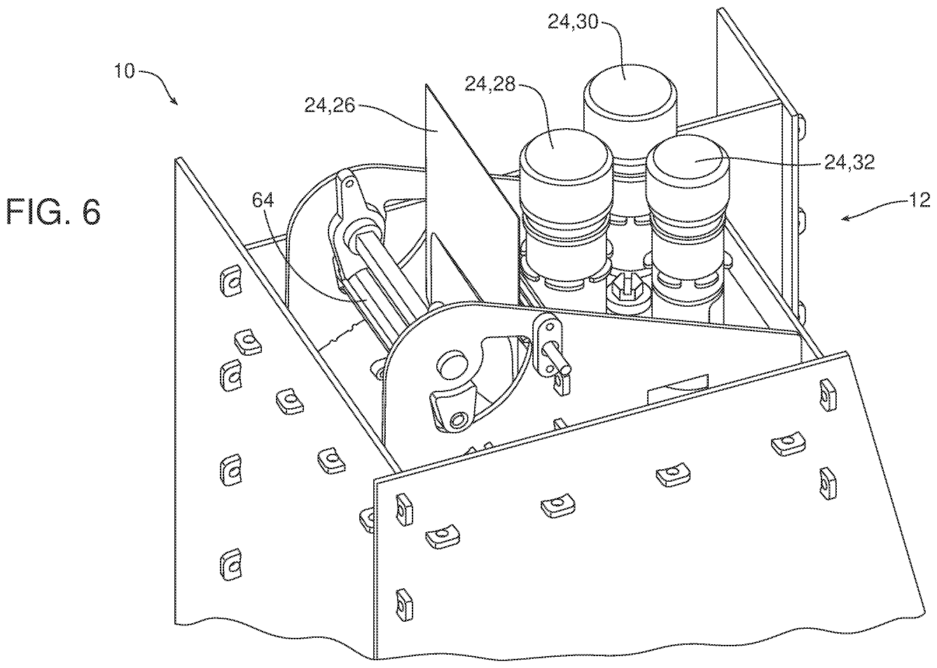

When the temperature of the heating and mixing vessel cools down to a second predetermined temperature of about 75° C. to about 95° C., as determined by the first temperature sensor 106, the controller 102 activates the first drive 72 causing the roller 64 to squeeze the gelatin bloom from the pouch 26 into the sugar mixture in the heating and mixing vessel 16. FIG. 5 illustrates the roller 64 in the home or starting position above the gelatin bloom in the pouch 26. The roller 64 is then pivoted in a sweeping motion to the fully advanced and discharging position illustrated in FIG. 6. As this movement occurs, the roller 64 squeezes the pouch 26 forcing the gelatin bloom from the pouch.

Mixing by the agitator 80 continues until the temperature in the heating and mixing vessel falls to a third predetermined temperature of about 30° C. to about 45° C. (once again as monitored and confirmed by the first temperature sensor 106) and the ingredient mixture held therein has the desired viscosity. At that time, the controller 102 activates the fourth drive 78 to discharge the botanical ingredients from the third canister 32 into the heating and mixing vessel 16. The botanical ingredients may comprise, for example, an oil, distillate, concentrate or tincture of any desired botanical.

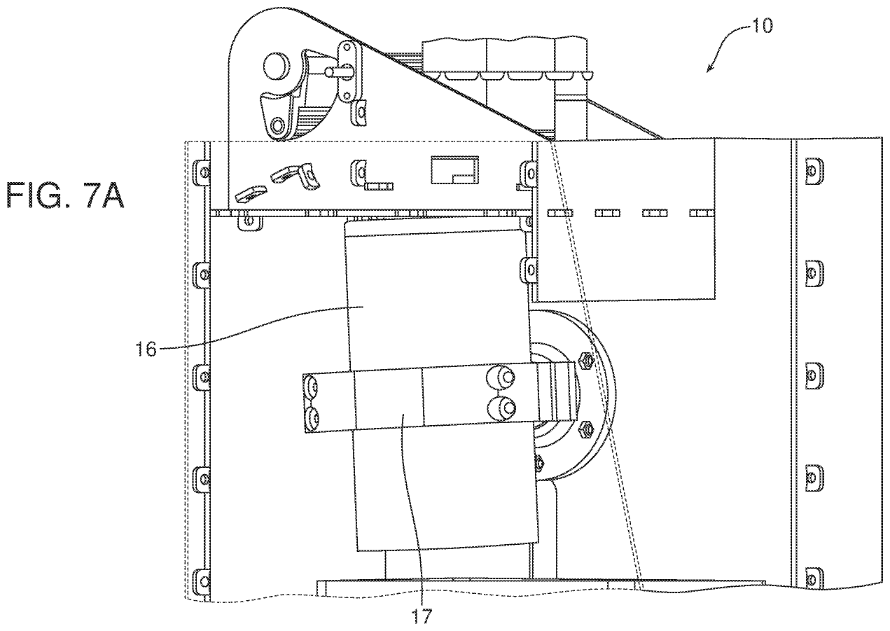

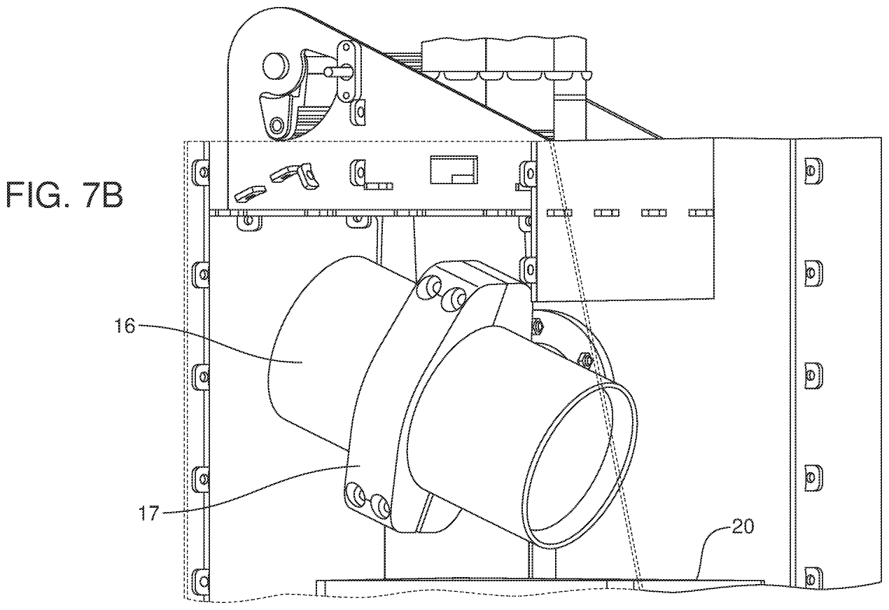

The controller 102 continues the slow mixing of the now complete candy formulation held in the heating and mixing vessel 16 by controlled operation of the agitator 80 for approximately 15 additional minutes. At that point, the controller 102 controls the tipper 84 to cause a controlled, timed, slow pour of the candy making formulation into the underlying molding tray 20 in the cooling chamber 18. This prevents spilling and ensures even filling of the tray 20. FIG. 7A illustrates the heating and mixing vessel 16 in the heating and mixing position. The heating and mixing vessel 16 is held in the cradle 17 which is pivoted by the tipper 84 to slowly displace the heating and mixing vessel into the final pouring position illustrated in FIG. 7B.

Once the pouring is completed, the controller 102 activates the vibrator 82 to vibrate the tray 20 for about 10 seconds. The vibration is then paused for about 30 seconds and then the tray 20 is once again vibrated for another ten seconds. This approach tends to release any air bubbles in the candy formulation held in the tray 20.

The cooling chamber 18 is maintained at a fourth predetermined temperature of between about 1.1° C. to 3.3° C. by the cooling element 112 under the control of the controller 102. Cooling continues for approximately one hour at which time the controller 102 provides an indication on the display screen 116, by indicator lamp 118 and/or by audio signaling device 120 to the operator/user that the edible candy sheet is ready. The user then opens the access door to the cooling chamber 18 and removes the molding tray 20 holding the edible candy sheet. The edible candy sheet may then be cut in any manner known in the art into edible treats of any desired size. Those treats may be dipped into any sugar or flavoring powder and/or consumed direct from the tray 20. Apparatus cleaning instructions may then be displayed by the controller 102 on the display screen 116.

This document may be said to relate to the following items.

1. A candy making apparatus, comprising:
an ingredient staging section;
a heating and mixing vessel downstream from the ingredient staging section;
a cooling chamber downstream from the heating and mixing vessel; and
a removable molding tray in the cooling chamber;
whereby candy making ingredients are delivered from the ingredient staging section to the heating and mixing vessel where said ingredients are heated and mixed to form a candy formulation before being delivered into the molding tray in the cooling chamber.

2. The candy making apparatus of item 1, further including a heating element adapted for heating the heating and mixing vessel and a cooling element adapted for cooling the cooling chamber.

3. The candy making apparatus of item 2, further including a control module including a controller, a timer, a first temperature sensor and a second temperature sensor wherein (a) the first temperature sensor is adapted to sense a mixing temperature of the ingredients in the heating and mixing vessel, (b) the second temperature sensor is adapted to sense a setting temperature in the cooling chamber and (c) the controller is responsive to the sensed mixing temperature and the sensed setting temperature to control operation of the heating element and the cooling element and production and processing of edible candy product.

4. The candy making apparatus of item 3, wherein the ingredient staging section includes a plurality of receivers adapted to receive and hold a plurality of different containers holding candy making ingredients.

5. The candy making apparatus of item 4, wherein the ingredient staging section further includes an ingredient feeder for each of the plurality of different containers.

6. The candy making apparatus of item 5, wherein the plurality of receivers include three canister receivers and one pouch receiver.

7. The candy making apparatus of item 6, wherein the plurality of containers include a wet sugar canister, a dry sugar canister and a botanical ingredient canister.

8. The candy making apparatus of item 7, wherein the plurality of different container include a gelatin pouch.

9. The candy making apparatus of item 8, wherein the gelatin pouch includes a first compartment holding a gelatin powder, a second compartment holding a mixing liquid and a burstable internal seal dividing the first compartment from the second compartment.

10. The candy making apparatus of item 9, wherein the gelatin pouch includes a discharge opening at one end and a discharge opening seal.

11. The candy making apparatus of item 10, wherein the three canister receivers each include a keyed receiving collar.

12. The candy making apparatus of item 11, wherein (a) the keyed receiving collar on a first of the three canister receivers is adapted to match a keyed plug on a discharge end of the wet sugar canister, (b) the keyed collar on a second of the three canister receivers is adapted to match a keyed plug on a discharge end of the dry sugar canister and (c) the keyed collar on a third of the three canister receivers is adapted to match a keyed plug on a discharge end of the botanical ingredient canister.

13. The candy making apparatus of item 12, wherein the pouch receiver includes a pouch support stand.

14. The candy making apparatus of item 13, wherein the ingredient feeder includes a displaceable roller adapted to squeeze gelatin ingredients from the pouch so that the gelatin ingredients are squeezed through the discharge opening into the heating and mixing vessel.

15. The candy making apparatus of item 14 wherein the ingredient feeder includes a first piston adapted for pushing the wet sugar from the wet sugar canister, a second piston adapted for pushing the dry sugar from the dry sugar canister and a third piston adapted for pushing the botanical ingredients from the botanical canister.

16. The candy making apparatus of item 15, wherein the ingredient feeder include a first driver adapted for displacing the displaceable roller, a second driver adapted for displacing the first piston, a third driver adapted for displacing the second piston and a fourth driver adapted for displacing the third piston.

17. The candy making apparatus of item 16, wherein the controller is further adapted to control operation of the first driver, the second driver, the third driver and the fourth driver.

18. The candy making apparatus of item 17, further including (a) an agitator in the mixing vessel adapted for mixing the candy making ingredients during heating, (b) a vibrator adapted for vibrating the molding tray and removing air bubbles in the candy formulation discharged into the molding tray and (c) a tipper adapted for pouring the candy formulation from the heating and mixing vessel into the molding tray.

19. The candy making apparatus of item 18, further including an ingredient scanner adapted to read a code on at least one of the plurality of different containers.

20. The candy making apparatus of item 19, wherein (a) the controller is further adapted to control operation of the agitator, the vibrator and the tipper and (b) the controller is responsive to the code read by the ingredient scanner to confirm the ingredient in the at least one of the plurality of different containers is approved for candy making.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a canister”, as used herein, may also refer to, and encompass, a plurality of canisters.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the candy making apparatus of this disclosure has been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

Thus, while the above detailed description describes use of the candy making apparatus 10 to make botanical-infused gummies, it should be appreciated that one may also use the apparatus 10 to make chocolates, and hard candies, by simply using the appropriate ingredients. By selecting the type of candy to be made (e.g. gummies, chocolates or hard candy), the controller 102 will automatically adjust the processing parameters, such as (a) mixing speeds and times, (b) cooking temperature and time, (c) cooling temperature and time, and (d) setting temperature and time, as required to make the desired candy product.

What is claimed:

1. A candy making apparatus, comprising:
an ingredient staging section;
a heating and mixing vessel downstream from the ingredient staging section;
a cooling chamber downstream from the heating and mixing vessel; and
a removable molding tray in the cooling chamber;
whereby candy making ingredients are delivered from the ingredient staging section to the heating and mixing vessel where said ingredients are heated and mixed to form a candy formulation before being delivered into the molding tray in the cooling chamber.

2. The candy making apparatus of claim 1, further including a heating element adapted for heating the heating and mixing vessel and a cooling element adapted for cooling the cooling chamber.

3. The candy making apparatus of claim 2, further including a control module including a controller, a timer, a first temperature sensor and a second temperature sensor wherein (a) the first temperature sensor is adapted to sense a mixing temperature of the ingredients in the heating and mixing vessel, (b) the second temperature sensor is adapted to sense a setting temperature in the cooling chamber and (c) the controller is responsive to the sensed mixing temperature and the sensed setting temperature to control operation of the heating element and the cooling element and production and processing of edible candy product.

4. The candy making apparatus of claim 3, wherein the ingredient staging section includes a plurality of receivers adapted to receive and hold a plurality of different containers holding candy making ingredients.

5. The candy making apparatus of claim 4, wherein the ingredient staging section further includes an ingredient feeder for each of the plurality of different containers.

6. The candy making apparatus of claim 5, wherein the plurality of receivers include three canister receivers and one pouch receiver.

7. The candy making apparatus of claim 6, wherein the plurality of containers include a wet sugar canister, a dry sugar canister and a botanical ingredient canister.

8. The candy making apparatus of claim 7, wherein the plurality of different container include a gelatin pouch.

9. The candy making apparatus of claim 8, wherein the gelatin pouch includes a first compartment holding a gelatin powder, a second compartment holding a mixing liquid and a burstable internal seal dividing the first compartment from the second compartment.

10. The candy making apparatus of claim 9, wherein the gelatin pouch includes a discharge opening at one end and a discharge opening seal.

11. The candy making apparatus of claim 10, wherein the three canister receivers each include a keyed receiving collar.

12. The candy making apparatus of claim 11, wherein (a) the keyed receiving collar on a first of the three canister receivers is adapted to match a keyed plug on a discharge end of the wet sugar canister, (b) the keyed collar on a second of the three canister receivers is adapted to match a keyed plug on a discharge end of the dry sugar canister and (c) the keyed collar on a third of the three canister receivers is adapted to match a keyed plug on a discharge end of the botanical ingredient canister.

13. The candy making apparatus of claim 12, wherein the pouch receiver includes a pouch support stand.

14. The candy making apparatus of claim 13, wherein the ingredient feeder includes a displaceable roller adapted to squeeze gelatin ingredients from the pouch so that the gelatin ingredients are squeezed through the discharge opening into the heating and mixing vessel.

15. The candy making apparatus of claim 14 wherein the ingredient feeder includes a first piston adapted for pushing the wet sugar from the wet sugar canister, a second piston adapted for pushing the dry sugar from the dry sugar canister and a third piston adapted for pushing the botanical ingredients from the botanical canister.

16. The candy making apparatus of claim 15, wherein the ingredient feeder include a first driver adapted for displacing the displaceable roller, a second driver adapted for displacing the first piston, a third driver adapted for displacing the second piston and a fourth driver adapted for displacing the third piston.

17. The candy making apparatus of claim 16, wherein the controller is further adapted to control operation of the first driver, the second driver, the third driver and the fourth driver.

18. The candy making apparatus of claim 17, further including (a) an agitator in the mixing vessel adapted for mixing the candy making ingredients during heating, (b) a vibrator adapted for vibrating the molding tray and removing air bubbles in the candy formulation discharged into the molding tray and (c) a tipper adapted for pouring the candy formulation from the heating and mixing vessel into the molding tray.

19. The candy making apparatus of claim 18, further including an ingredient scanner adapted to read a code on at least one of the plurality of different containers.

20. The candy making apparatus of claim 19, wherein (a) the controller is further adapted to control operation of the agitator, the vibrator and the tipper and (b) the controller is responsive to the code read by the ingredient scanner to confirm the ingredient in the at least one of the plurality of different containers is approved for candy making.
